(19) United States
(12) Patent Application Publication
(10) Pub. No.: US 2007/0037544 A1
(43) Pub. Date: Feb. 15, 2007

(54) Integrated RF circuits

(75) Inventor: Jari J. Heikkinen, Salo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/483,541

(22) Filed: Jul. 11, 2006

(30) Foreign Application Priority Data
Jul. 11, 2005 (FI) 20055401

(51) Int. Cl. H04B 1/26

(52) U.S. Cl. 455/323

(57) ABSTRACT

An on-chip response adjuster is based on an on-purpose generated and dominant transfer pole or zero of a signal response so as to provide a process-stable phase behavior of the circuitry. The signal response is defined directly by a passive frequency variant component (Lfold) and by transistor operation point, e.g. biasing, of a transistor configuration (Qcas,Qaux). As a result, electrically controlled signal response adjusters can be provided with fully integrated, single-chip integrated or system-on-chip (SoC) techniques.

### FIELD OF THE INVENTION

The present invention relates to radio-frequency (RF) integrated circuits, and particularly to integrated RF linearization, correction and compensation circuits.

### BACKGROUND OF THE INVENTION

In integrated circuit (IC) technology, large variations in component values between different wafers have traditionally excluded the IC implementations for circuit structures that are sensitive to phase and amplitude behaviour of the signal response in general Radio Frequency Integrated Circuit (RFIC) processes. The uncontrollable signal response behavior (phase & amplitude) of the electrical devices caused by process variations and mismatches in general integrated circuit processes cause various unwanted features in the overall performance. These kinds of circuit structures are, for instance, traditional radio frequency linearization and modulation correction circuitries, in which the uncontrollable signal response behavior cause vector error in modulation methods or inaccuracy in linearization or feedback loops.

Traditional discrete design methods, e.g. electrical lengths of microstrip lines, external bulky phase shifters, and attenuators in RF linearization do not usually provide a high-resolution adaptivity and adjustment for controlling the signal response, which is a classic advantage of integrated circuit processes. This approach further suffers from many inaccuracies especially mismatch of active elements and the external interfaces like packaging and bonding, which cause production yield problems. Also the electrical length has a significant frequency limitation, which has forced to utilize different kind of control mechanism. Furthermore, a phase shift realized by an external strip line is frequency selective and will deteriorate the wideband operation of the linearization. The miniaturization is the answer to these problems, but until now, the process parameter variations have been an overcoming problem.

The efficiency of a transmitter chain has drawn a great attention as a research topic for many years in telecommunication systems. The standby time of battery-operated appliances and the high-cost transmitter chain in infrastructural business has been the main drivers to innovate continually better and better linearization methods to improve the transmitter efficiency.

In many cases the most stringent requirements for the linearity of a receiver is originated by a system itself, e.g. co-sited in the infrastructural business and multi-radio environment inside a mobile phone. The compensation of this “self-inflicted” interference would alleviate the requirements of many other systems. Usually the linearization concept is fully referred to the intermodulation cancellation. Another more receiver or system specific aspect related to multi-radio concepts is the cross-modulation cancellation, since the intermodulation can be cancelled by a proper frequency planning. The leaking strong on-chip or out-of-chip interference radiates with multipath propagation to the sensitive part. This multipath propagation (e.g. substrate isolation and a Duplex filter) forms transmission zeros but very seldom to the wanted area (e.g. a low noise amplifier, LNA, input).

In addition, the component mismatches cause an error in the quality of the modulation. Thus, different kinds of modulation correction circuitries are needed for high-speed data services in which a high quality of the modulation is required.

Integrated circuit implementations have been reported providing moderate response balance without compensation at lower frequencies where component parasitics are insignificant and can be ignored and no separate phase adjustment is needed. However, these implementations have remained in laboratory phase without commercial products. Examples of such implementations are disclosed in:

Analysis and Design of Feed-Forward Current Mode Amplifiers using Individual Suppression of Complex Harmonics, Y. Bruck et al, pages 88-93.

Monolithic Amplitude and Phase Control Circuits for 17/18 GHz Indoor Radio Applications, S. Nam et al, 1996, pages 5/1-5/6.

### BRIEF DESCRIPTION OF EMBODIMENTS OF THE INVENTION

An object of the present invention to provide an integrated circuit solution alleviating or overcoming the above problems particularly in radio frequency linearization, isolation boosting and modulation correction circuitries.

The object of the invention is achieved by the invention according to the attached independent claims. The preferred embodiments of the invention are disclosed in the dependent claims.

According to a first aspect of the invention, an on-chip response adjuster is based on an on-purpose generated and dominant transfer pole or zero of a signal response so as to provide a process-stable phase behavior of the circuitry. The signal response is defined directly by a passive frequency variant component (e.g. an inductor, a capacitor or a strip line) and by transistor operation point, e.g. biasing, of a transistor configuration. In an embodiment of the invention, the process-stable phase behavior of the circuitry can be electrically controlled by means of tuning the impedance, e.g. input impedance, of a transistor configuration. As a result, electrically controlled signal response adjusters can be provided with fully integrated, single-chip integrated or system-on-chip (SoC) techniques.

The first aspect of the invention allows structures for a direct radio frequency linearization to be implemented entirely on-chip inside general RFIC processes. Many advantages can be found only by the miniaturization itself, which has often been the main justifier to any technical decision in the telecommunication business. However, the main driver of this invention is not only the miniaturization itself but also the improvement of the performance. The wideband operation is an important quantity, which is resulted by a negligible electrical length inside a RFIC chip. Accurate resolution for the electrical controlling is easy to implement inside a RFIC chip. This is an important quantity related to the adaptivity and also to the performance. Component matching inside the RFIC chip gives a relative correlation between e.g. main and error branches in frequency, power, temperature, aging, and interference domains. The invention enables the implementation of wideband, accurate, and adaptive structures for any general RF linearization including receiver type of linearization, without the problems of the discrete solutions. An error in the quality of the modulation due to the component mismatches can be easily corrected with on-chip signal response adjustment according to the present invention response without the electrical length (on-chip).

Regarding the compensation of multi-radio interference in a receiver, the present invention allows to form a single controllable interference path (with a sufficient tuning range) from the source to the sensitive part. Simple analysis with a superposition method has demonstrated that with certain amplitude and phase settings this overall leaking interference (e.g. substrate coupling, bonding wire coupling, and controllable coupling) can be cancelled. In many embodiments, the tuning or adjusting is carried out in relation to another signal branch. For example, I- and Q-branches may be adjusted in relation to each other in a quadrature local oscillator, or an error signal branch may be adjusted in relation to a main signal branch in a feedforward linearizer.

According to a second aspect of the invention, an on-chip response adjuster is based on generation of at least two signal components with mutually different phases from an input signal to be shaped, and a current summing of the generated differently-phased signals to produce the wanted output of the signal response. In a preferred embodiment, the generated differently-phased signals comprise quadrature signals. The quadraturizing of the signal may be done with traditional methods, such as RC-polyphase, RL-polyphase or divided-by-two -circuitries. In an embodiment, differential input signal and differential quadrature signals and at least two current summers are provided. In an embodiment to manipulate quadrature signal, the number of current summers and the outputs are multiplied. The tuning or adjusting is carried out in relation to another signal branch. For example, I- and Q-branches may be adjusted in relation to each other in a quadrature local oscillator, or an error signal branch may be adjusted in relation to a main signal branch in a feedforward linearizer.

Advantages of the adjuster according to the second aspect of the invention include adaptivity and extremely large response tuning range especially in phase, 0 . . . 360 degrees; relatively small die area; and design process is alleviated, since phase tuning phase must not be considered.

### BRIEF DESCRIPTION OF THE DRAWINGS

In the following the invention will be described in greater detail by means of example embodiments with reference to the attached drawings, in which

FIGS. 1A and 1B show generic schematic and a simplified equivalent circuit diagram, respectively, for the signal response adjuster based on the RL HPF.

FIGS. 2A and 2B are graphs which depict amplitude and phase of the signal response of the embodiment shown in FIGS. 1A and 1B with different current values; FIGS. 3A, 3B and 3C show generic schematic circuit diagrams for the signal response adjuster based on the RC LPF;

FIG. 4 is a graph which depicts amplitude and phase of the signal response of the embodiments shown in FIGS. 3A-3C;

FIG. 5 shows a generic block diagram for a linearization loop of a low-noise amplifier (LNA);

FIG. 6A is a schematic diagram showing an example of implementation of the circuit shown in FIG. 5;

FIG. 6B illustrates an example implementation of the circuit of FIG. 5 for two signals, such as I- and Q-signals;

FIGS. 7, 8, 9, 10, 11, and 12 are graphs showing simulation results of the circuits of FIGS. 6A and 6B, wherein FIG. 12 is differently biased to optimize operation at higher output power levels;

FIG. 13 is a schematic diagram showing an example implementation for phase and amplitude correction of a local oscillator (LO) signal; and

FIG. 14 illustrates phase tuning at 2 GHz with auxiliar bias current in amplitude phase (left) and in polar form (right) for the circuit of FIG. 13;

FIG. 15 shows an example of a signal adjuster according to the second aspect of the invention;

FIGS. 16A and 16B show the ideal (A) and non-ideal (B) signal component outputs of the quadrature generator and the corresponding influence on overall tuning range (dashed line).;

FIG. 17 shows an example of a current summer;

FIG. 18 shows an example of a current summer utilizing a folded cascoded common-collector transistor configuration;

FIG. 19 shows a signal response adjuster suitable for a quadrature LO operation;

FIG. 20A shows a feedforward type of linearization with a signal cancellation loop;

FIG. 20B shows a two stage SiGe power amplifier used as a core for linearization training;

FIG. 20C illustrates behavior of a linearized power amplifier in power domain;

FIG. 20D illustrates a response of a linearized PA in frequency domain;

FIG. 20E illustrates behavior of a slightly tuned (with current summers) linearization circuitry optimized for higher output power;

FIG. 21 shows a feedforward type of linearization without a signal cancellation loop;

FIG. 22 shows a circuitry for optimization of LO duty-cycle of the local oscillator (LO) chain for down- or up-conversion mixer operation

FIG. 23 shows a signal balance compensation of a direct-down-conversion mixer;

FIG. 24 shows signal balance compensation of a direct-up-conversion mixer;

FIG. 25 shows the isolation boosting of TX output from a low-noise amplifier (LNA) input;

FIG. 26 shows an example of a general quadrature compensation to improve the quality of modulation; and

FIG. 27 shows a general configuration of adjustable feedback for an amplifier and oscillator purposes.

### DESCRIPTION OF EXAMPLE EMBODIMENTS

First Aspect of the Invention

Examples of embodiments implementing the principles implementing the first aspect of the invention are now described. The topologies used the example embodiments of the invention are specific folded cascode topologies for RF frequencies. This enables improved operation with low supply voltages and straightforward transistor biasing, since every transistor has an own independent direct current (DC) path. However, the main idea is equivalent for more traditional cascode topologies, and the conversion to more traditional cascode topologies is easy and apparent to those skilled in the art. For some appliances these traditional structures can be more appropriate, for instance, due to better common-mode behaviour or better even-order linearity. In addition, most of the implementations described can operate relatively regarding to another comparable signal path, for instance, in-phase (I) and quadrature (Q) branches of quadrature local oscillator (LO) or the main and error branches of the feedforward linearization. Furthermore, all the presented topologies are RF folded cascoded, but the main idea is equivalent for more traditional cascode topologies.

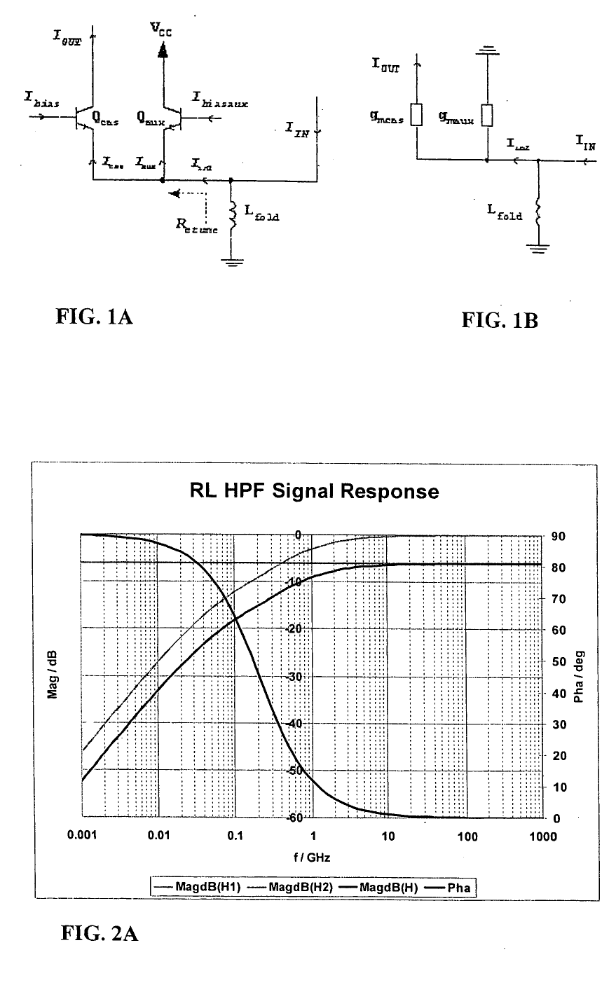

A first example of the implementation of the invention shown in FIGS. 1A and 1B is an adjustable Signal Response Shifter based on RL High Pass Filter (RL HPF). The present topology is a folded cascode but a conventional cascading is conceivable as well. The topology of two transistor devices Q_{cas} and Qₐᵤₓ and one inductor device Lfold can be seen as a traditional by-pass connected Gilbert cell with current-mode high impedance input I_{IN} and output I_{OUT}. The use of the by-pass branch aux improves the independence of the phase and amplitude control from each other. The emitters of the transistor devices Q_{cas} and Qₐᵤₓ are interconnected to each other and further to first terminal of the inductor device L_{fold}. The second terminal of the inductor device L_{fold} is connected to a lower potential, such as the ground potential. The first terminal of inductor device L_{fold} receives the input current I_{IN} and a portion I_{IN2} of the input current flows to the interconnection point of the transistor devices Q_{cas} and Qₐᵤₓ wherein the current I_{IN2} is divided to the currents I_{cas} and Iₐᵤₓ flowing through the respective transistors. The current flowing at the collector of the transistor device Q_{cas} establishes the output current I_{OUT}. The magnitude of the currents I_{cas} and Iₐᵤₓ and thereby the relation of the currents I_{IN}, I_{IN2} and I_{OUT} is controlled by the base currents I_{bias} and I_{biasaux}, respectively. Basically, the amplitude control is implemented by changing the biasing and operations point currents of the main cascade branch Q_{cas} and the by-pass cascade branch Qₐᵤₓ with respect to each other. The impedance at the interconnection point remains constant but a current-type power division is formed between the cascade branches. The phase is controlled by changing the sum current I_{IN2}.

The transfer function of the circuit of FIGS. 1A and 1B can be given as

$$\frac{{I}_{OUT}}{{I}_{IN}} ( ω ) = \frac{{I}_{OUT}}{{I}_{i n 2}} ( ω ) \cdot \frac{{I}_{i n 2}}{{I}_{IN}} ( ω ) = \frac{{g}_{mcas}}{{g}_{mcas} + {g}_{maux}} \cdot \frac{{g}_{mcas} + {g}_{maux}}{{g}_{mcas} + {g}_{maux} + \frac{1}{jω {L}_{fold}}} \qquad ( 1 )$$

The transistor Q_{cas} is forming the main cascode branch over the signal path I_{OUT}/I_{IN}. The transistor Qₐᵤₓ is forming a by-passed cascode branch, which forms a current mode power divider together with the main cascode branch, which forms a current mode power divider together with the main cascode branch; working as the first factor in I_{OUT}/Iᵢₙ₂) in the Equation 1. The parallel inductor L_{fold} forms a controllable transfer zero (second factor Iᵢₙ₂/I_{IN} in Equation 1) together with the combined input impedance of the cascode branches Rₑₜᵤₙₑ=1(g_{mcas}+gₘₐᵤₓ). The magnitude of Equation 1 can be written as

$$\vert \frac{{I}_{OUT}}{{I}_{IN}} ( ω ) \vert = \frac{{g}_{mcas}}{{g}_{mcas} + {g}_{maux}} \sqrt{\frac{{( ω {L}_{fold} ( {g}_{mcas} + {g}_{maux} ) )}^{2} + {( ω {L}_{fold} ( {g}_{mcas} + {g}_{maux} ) )}^{4}}{{( {( 1 + ω {L}_{fold} ( {g}_{mcas} + {g}_{maux} ) )}^{2} )}^{2}}} ≅ \frac{{g}_{mcas}}{{g}_{mcas} + {g}_{maux}} \qquad ( 2 )$$

and the phase component can be written as

$$\frac{{I}_{out}}{{I}_{IN}} ( ω ) = {tan}^{- 1} ( \frac{1}{ω {L}_{fold} ( {g}_{mcas} + {g}_{maux} )} ) . \qquad ( 3 )$$

The relation between a collector current I_{c} and a gonductance gₘ for bipolar transistors is the well known

Thus, changing a bias current I_{bias} and/or I_{biasaux} will change the current I_{cas} and/or Iₐᵤₓ and thereby the confuctance gₘ of the respective transistor Q_{cas} and/or Qₐᵤₓ.

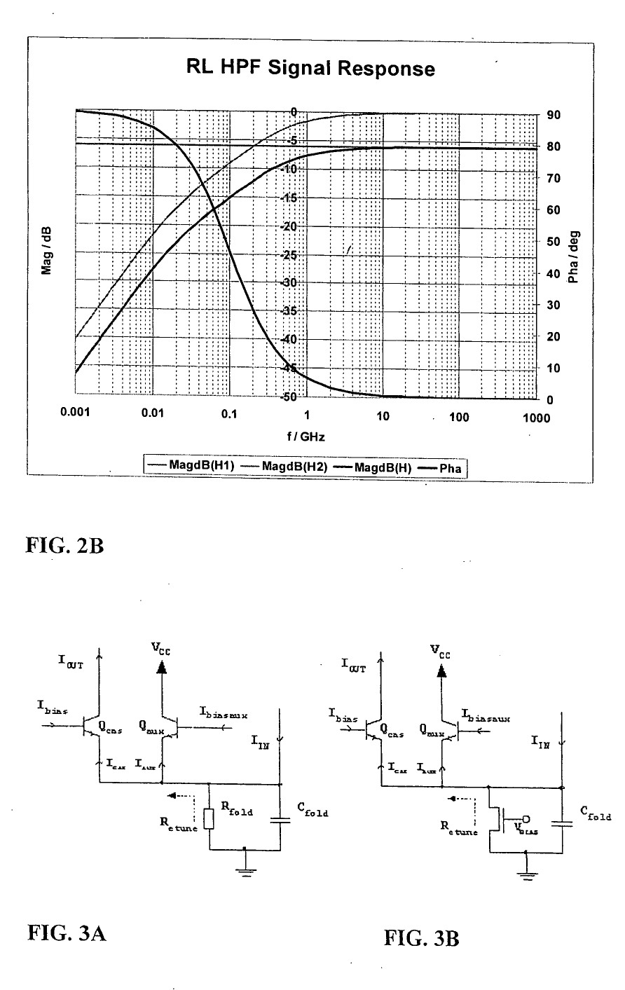

These equations and the effect of the currents I_{cas} and/or Iₐᵤₓ on the amplitude and phase responses can be studied in more detail from the FIGS. 2A and 2B. FIG. 2A depicts amplitude of the signal responses H1, H2 and H, as well as phase of the signal response H, when the inductance L_{fold}=2nH, and cascode currents Icas=10 mA and Iaux=10 mA at temperature of 27 Celsius degrees, wherein H=H1*H2=Iout/Iin, H1=Iin2Iin, and H2=Iout/Iin2. FIG. 2B which depicts amplitude of the signal responses H1, H2 and H, as well as phase of the signal response H, when the inductance Lfold=2nH, and cascode currents Icas=6 mA and Iaux=6 mA at temperature of 27 Celsius degrees, wherein H=H1*H2=Iout/Iin, H1=Iin2/Iin, and H2=Iout/Iin2. It can be seen that phase has changed without change in amplitude.

A second example of the implementation of the invention shown in FIGS. 3A and 3B is an adjustable Signal Response Shifter based on RC Low Pass Filter (RC LPF). The signal response mechanism of the second example is a partial component inversion/conversion of the mechanism of the first embodiment shown in FIGS. 1A and 1B, and therefore, the simple theory is not derived herein, but a reference is made to the first embodiment. Again, the topology of two transistor devices Q_{cas} and Qₐᵤₓ and other frequency dependent passive component, namely a capacitor C_{fold} can be seen as a traditional by-pass connected Gilbert cell with current-mode high impedance input I_{IN} and output I_{OUT}.

As a result, the second example has the same principle as the first embodiment but now a controllable transfer pole is utilized to generate the accurate phase response. The capacitor device C_{fold} and the combined input impedance of the cascode branches Rₑₜᵤₙₑ are forming a RC low pass filter (RC LPF). A passive resistor R_{fold} (an embodiment shown in FIG. 3A) or an active device, such as a field effect transistor, (an embodiment shown in FIG. 3A) is used to form the DC path without a significant contribution to the transfer function. The resulting resistance (passive or active) complicates the biasing of the cascode transistors, which is now equivalent to a traditional cascode cell.

This topology forms a high Q-valued LPF enabling a wide tuning range of the signal response. Also the topology consumes a relatively small die area compared to the structure of the first embodiment. Because of the resistive DC path, the topology is not suitable for solutions requiring high current consumption also the biasing of the response-controlling core is more complex compared to the structure of the first embodiment of the invention.

The transfer function for the circuits shown in FIGS. 3A and 3B can

$$\frac{{I}_{OUT}}{{I}_{IN}} ( ω ) = \frac{{g}_{mcas}}{{g}_{mcas} + {g}_{maux}} \cdot \frac{{g}_{mcas} + {g}_{maux}}{{g}_{mcas} + {g}_{maux} + jω {C}_{fold}} \qquad ( 5 )$$

be given as

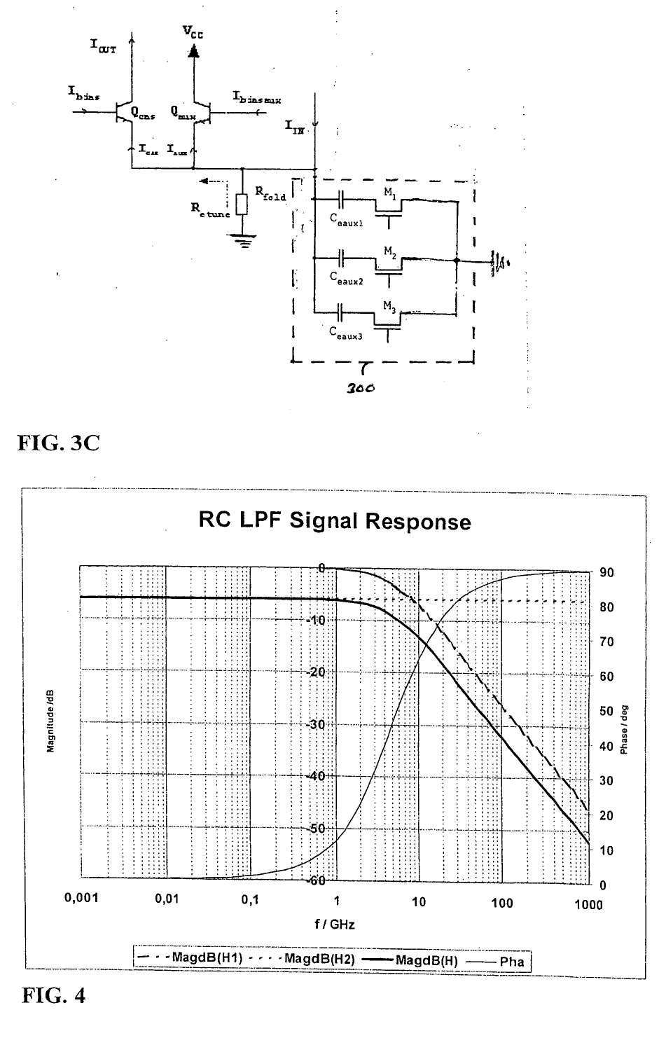

The phase and amplitude behaviour of the equation 5 can be studied in more detail from the FIG. 4 which depicts amplitude of the signal responses H1, H2 and H, as well as phase of the signal response H, when the inductance C_{fold}=5 pF, and cascode currents Icas=2 mA and Iaux=2 mA at temperature of 27 Celsius degrees, wherein H=H1*H2=Iout/Iin, H1=Iin2/Iin, and H2=Iout/Iin2.

As evident from the above, the phase tuning is generated with the sum current increment. In an embodiment of the invention shown in FIG. 3C, the tuning range is enlarged by replacing the tuning capacitor C_{fold} of FIGS. 3A and 3B with a capacitor matrix 300 to alleviate the required current adjustment range. The capacitor matrix 300 comprises selectable capacitors Cₑₐᵤₓ₁, Cₑₐᵤₓ₂, and Cₑₐᵤₓ₃ as well as transistor switches M1, M2, and M3 (such as NMOS transistor) which are controlled on and off so as to connect (select) or disconnect, respectively, the respective capacitor. The coarse tuning is performed with the capacitor matrix 300 and fine-tuning with the cascode biasing as described above.

The illustrated circuit configurations can be implemented as two signal versions (such as I and Q signals) by providing a similar circuit for the other signal too and the tuning is adjusted relatively. In this case, basically ideal and wideband tuning is possible.

The application area of the present invention is very wide, and therefore, only partially discussed herein. In the following, a couple of simulated implementation examples are presented. The implementations are divided into three sub-categories, namely modulation correction, RF linearization, and isolation compensation.

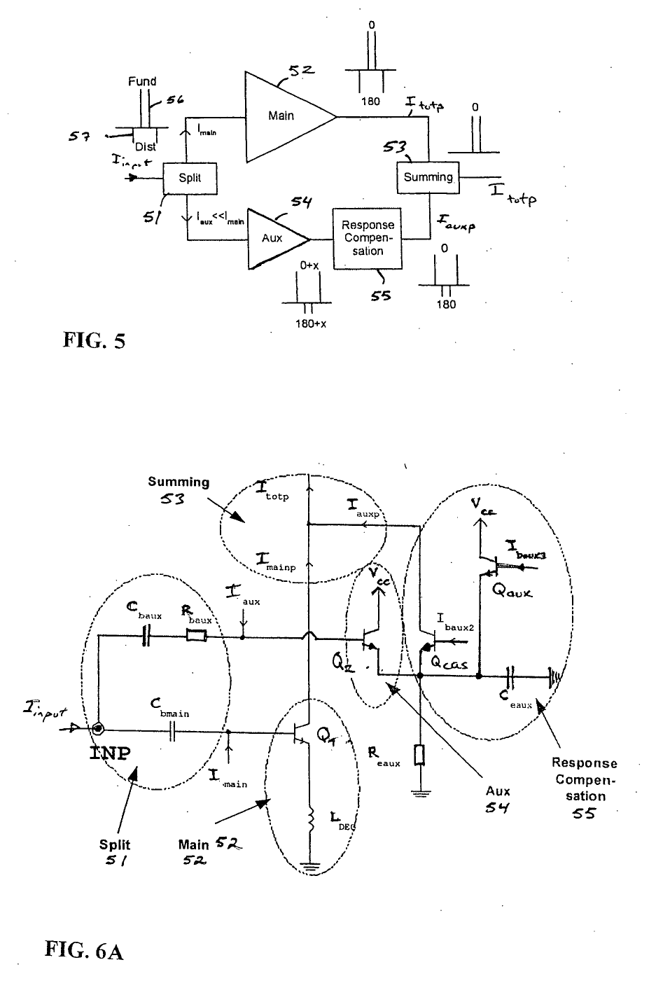

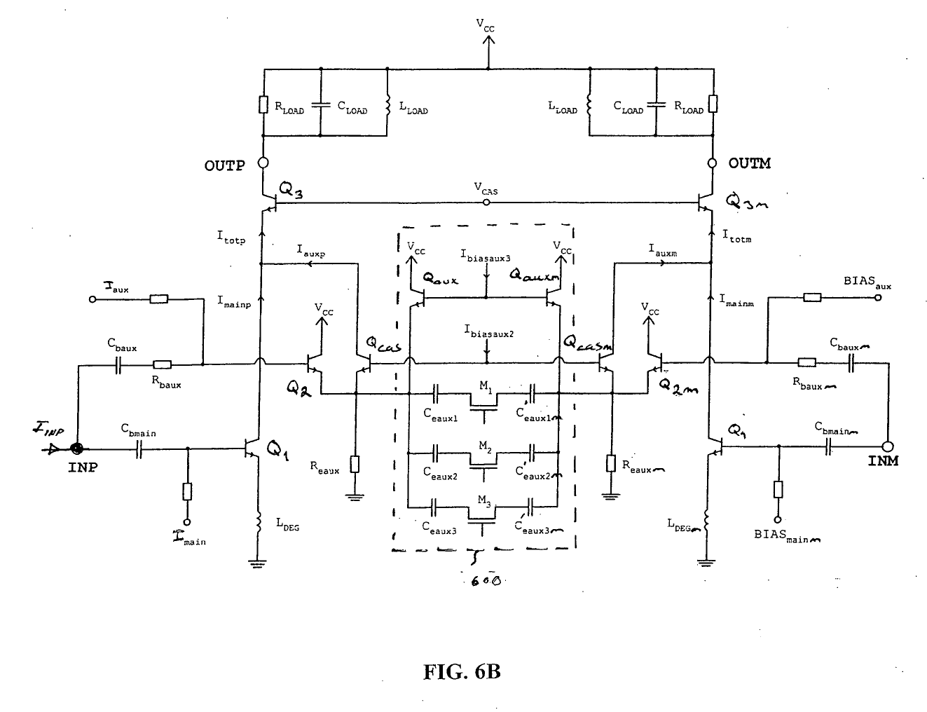

An implementation example for a receiver linearization is described with reference to FIGS. 5, 6A and 6B. FIG. 5 shows a generic block diagram for a linearization loop of a low-noise amplifier (LNA). A splitter device 51 splits an input signal current Iᵢₙₚᵤₜ into a main branch current Iₘₐᵢₙ and an auxiliary or error branch current Iₐᵤₓ which is a fraction of the main branch current. The main branch current Iₘₐᵢₙ is inputted to an inverting low-noise main amplifier 52. Output current Iₘₐᵢₙₚ of the main amplifier 52 is inputted to a summing device 53. The auxiliary or error branch current Iₐᵤₓ is inputted to a non-inverting auxiliary low-noise amplifier 54. An output current of the secondary amplifier 54 is inputted to a response compensation circuit 55 according to the invention. An output error current Iₐᵤₓₚ from the response compensation circuit 54 is inputted to the summing device 53 which combines the main branch current Iₘₐᵢₙₚ and the error branch current Iₐᵤₓₚ which have 180 degree phase difference. With appropriate operation of the error branch, the sum signal current Iₜₒₜₚ is linearized, i.e. the distortion in the signal reduced or cancelled.

FIG. 6A is a schematic diagram showing an example of implementation of the circuit shown in FIG. 5. The splitting device 51 is implemented by means of a divider which includes coupling capacitors C_{baux}, C_{bmain} and a resistor R_{baux}. The main amplifier 52 is implemented by means of a transistor Q₁ and an inductor L_{DEG}. The auxiliary amplifier 54 is implemented by means of a transistor Q₁. The response compensation circuit 55 is implemented by means of cascode transistors Qcas and Qaux, a capacitor Ceaux, and a resistor Reaux in a similar manner as the circuit shown in FIG. 3A. The summing device 53 is implemented by means of the interconnected collectors of the transistors Q₁ and Q_{cas}.

FIG. 6B illustrates an example implementation of the circuit of FIG. 6A for differential signals. The circuitry for the signal INP is identical with that shown in FIG. 6A. The circuitry for the signal INM is a mirror image of that for the signal INP and the respective components and signals are indicated with an additional subindex m. The capacitor Ceaux may further be replaced with a switching block 600 similar to the switching block 300 shown in FIG. 3C to enlarge the phase tuning range.

The illustrated linearization is a feedforward type of linearization without a signal cancellation loop. The linearization used is herein called as a fundamental reductive feedforward. The discussion about linearizing a transmitter is now directly re-focused on a receiver type of linearization to bring forward another side of the invention and particularly the wideband operation suitable for an on-chip RFIC implementation.

The circuit structure shown in FIGS. 5 and 6 is implemented as a parallel device in a secondary low-noise amplifier (LNA) design for infrastructural requirements. Thus, the traditional performance of the LNA is not degraded when the linearization is turned in the shutdown mode. The implementation is designed to linearize only the LNA block, but an analog pre-distortion aimed to the entire receiver (RX) chain is feasible as well. The topology is directly suitable for a variety of cascode circuits, such as Gilbert-cell mixers and VGAs.

A signal response matching of the main and the error braches over the feedback loop is a good starting point. The responses of the input matching or the load resonator do not understandably affect the relatively transfer function of the compensation loop.

The signal response of the main branch is simply dominated by a degeneration inductor L_{DEG} forming a dominant transfer pole. The corresponding transfer pole at the error branch is formed by a parallel capacitor Cₑₐᵤₓ simultaneously enabling a signal response adjustment of the error branch. The second transfer pole is originated by the frequency f_{T} of transistor devices, which can be harmonized by selecting equal emitter current densities for transistor devices. Capacitive AC-couplings C_{baux} and C_{bmain} form dominant transfer zeros at the input of both branches. These serial RC time constants are scaled to equal values by selecting capacitor values C_{baux} and C_{bmain}.

The distorsion 57 and fundamental 56 signals do not necessarily have an equal response matching over the frequency bandwidth. The intermodulation distortion (IMD) of the error branch may be clearly lower to not decrease the signal gain of the entire amplifier. This may be solved by a different amount of feedback in the main and error braches. Actually, the main branch may utilize the serial local feedback, while the common-collector common-base (CC-CB) transistor configuration utilized in the error branch may be implemented without an actual feedback. This enables a low third-order intermodulation distortion level (IMD₃) of this branch, and therefore, a low fundamental signal reduction of the entire linearized LNA.

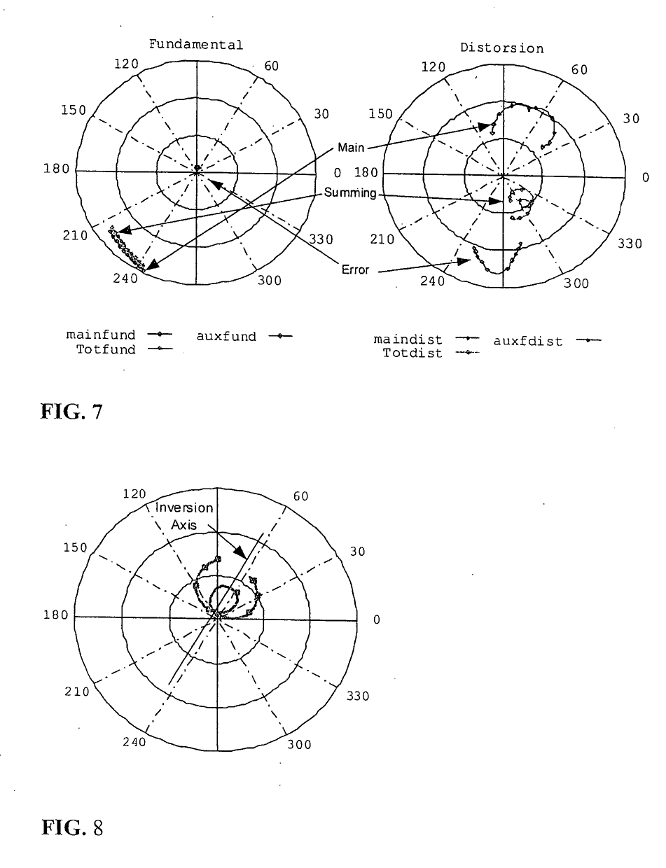

Simulation results of the circuit of FIG. 6 are shown in FIGS. 7 to 12. FIG. 7 depicts fundamental signal and distorsion currents at the summing point of the linearization loop presented in a polar diagram. The corresponding branches Iₜₒₜₚ, Iₘₐᵢₙₚ, and Iₐᵤₓₚ can be found from FIG. 6. In FIG. 7, the distortion sum (term Totdist at branch Iₜₒₜₚ) is not at the centre of the polar diagram, since the purpose is to optimise the distortion at the output. The linearization loop is actually operating as a pre-distortion to the cascode stage to the cascode stage (Q3 and Q3m in FIG. 6B).

FIG. 8 shows a voltage mode intermodulation (IM) distortion at the output of the linearized LNA.

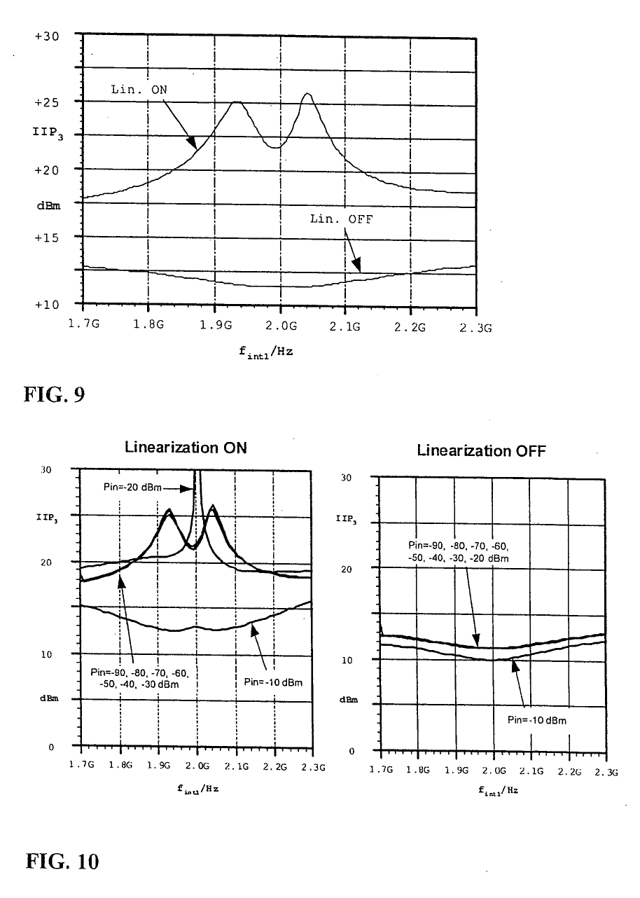

FIG. 9 shows the IIP₃ of the LNA with the linearization switched on and off. Two-tone test with fᵢₙₜ₁ and fᵢₙₜ₂=(2 GHz+fᵢₙₜ₁)/2 resulting the distortion product (2fᵢₙₜ₂−fᵢₙₜ₁) to 2 GHz. The input tone power is −30 dBm. For instance, fᵢₙₜ₁=1.7 GHz [symbol] fᵢₙₜ₂=1.85 GHz is resulting upper band distortion result (2fᵢₙₜ₂−fᵢₙₜ₁) at the wanted channel at 2 GHz with IIP₃ of +18 dBm. On the other hand, fᵢₙₜ₁=2.03 GHz [symbol] fᵢₙₜ₂=2.015 GHz is resulting lower band distortion result (2fᵢₙₜ₂−fᵢₙₜ₁) at the wanted channel with IIP₃ of +28 dBm. The distortion is measured in a voltage mode at the output of the LNA.

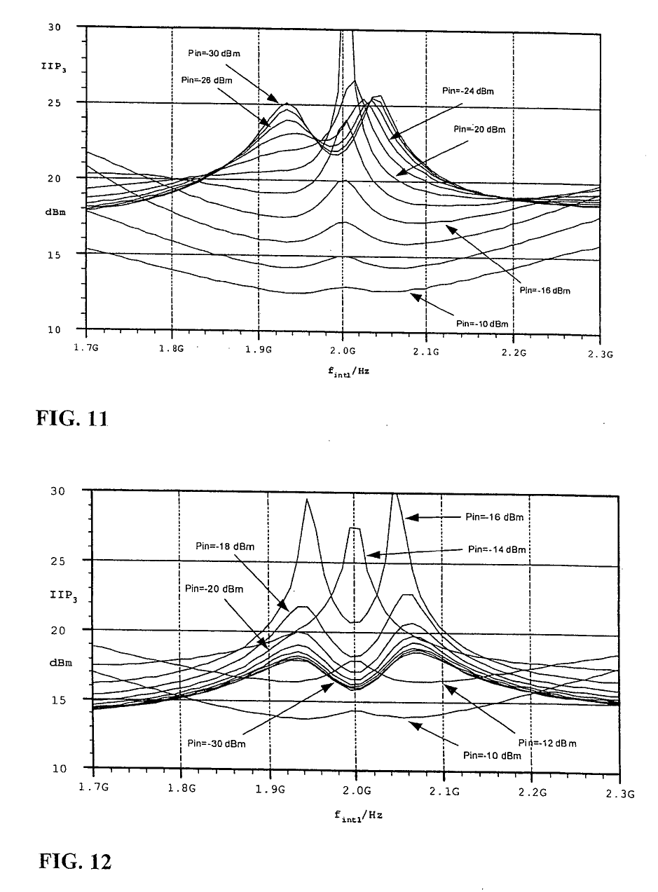

In the following, the IIP₃ performance over the power domain is concerned. FIG. 10 depicts the IIP₃ of the LNA with different tone powers and with the linearization switched on and off. More specifically, the tone power level is swept over −90 . . . −10 dBm for the linearization switched on and off. The linearization breakdown, in this case, occurs between power levels −20 and −10 dBm. It is notable that the same breakdown occurs without the linearization loop and the linearized LNA is still clearly more competent. In FIG. 11, the same test is performed with more accurate power domain sweep near the linearization breakdown.

In FIG. 12, small amplitude compensation by a relative current adjustment in the cascode stage of the compensation circuitry (I_{biasaux2}+I_{biasaux3} is constant in FIG. 6B) is performed. This increases the gain of the error branch and the linearization is more optimized to higher power levels at the expense of the performance at lower power levels.

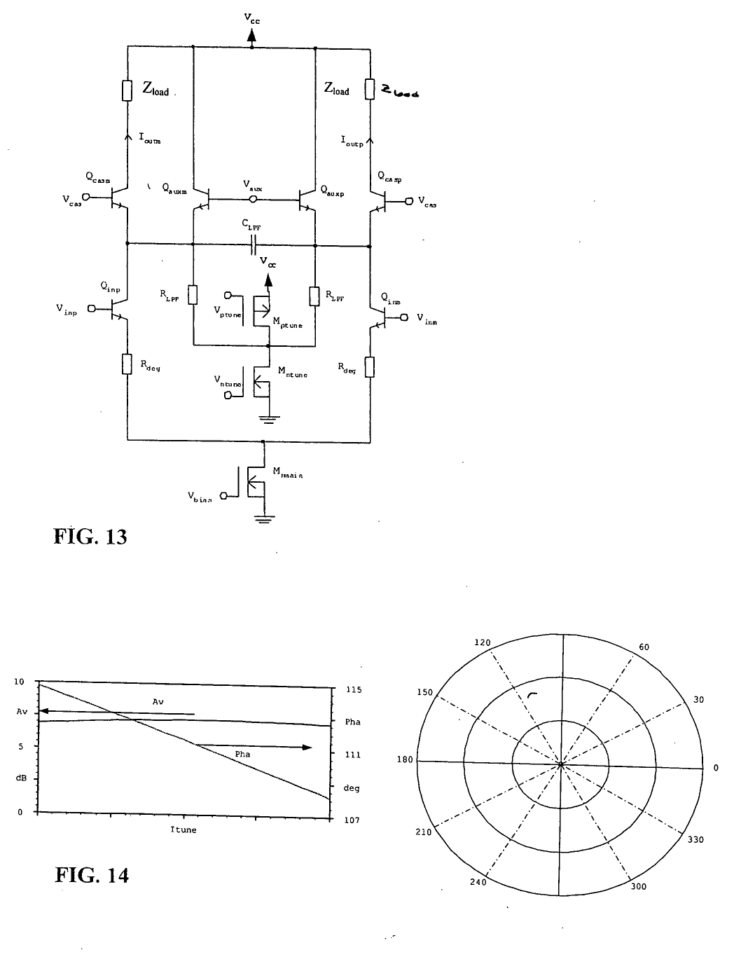

FIG. 13 is a schematic diagram showing an example implementation for phase and amplitude correction of a local oscillator (LO) signal in accordance with the principles of the present invention. In this example a traditional cascode amplifier configuration is employed instead of the folded cascode used in the above examples. However, the principles of the basic invention are still the same: a dominant transfer pole or zero of a signal response (in this case a pole) is created on purpose by means of passive frequency variant component and controlled by adjusting the transistor operation point of cascade transistors Q_{cas} and Qₐᵤₓ. The operation point of input devices (Qinp and Qinm) are constant regardless of the adjustments.

Transistor devices Q_{casm} and Qₐᵤₓₘ (Q_{casp} and Qₐᵤₓₚ) provide the cascade branches according to the present invention. The emitters of the transistor devices Q_{casm} and Qₐᵤₓₘ are interconnected to each other, to first terminal of low-pass filter capacitor C_{LPF}, and further through a low-pass filter resistor and a tuning transistor device Mₙₜᵤₙₑ to a lower potential (e.g. ground) and through a tuning transistor device Mₚₜᵤₙₑ to a higher potential (e.g. an operating voltage V_{c}). The second terminal of capacitor C_{LPF} is connected to of an amplifying transistor device Qᵢₙₘ, to the base of which an input signal Vᵢₙₘ is applied. The emitter of the amplifying transistor device Qᵢₙₘ is connected via a resistor R_{deg} and a biasing transistor Mₙₘₐᵢₙ to a lower potential, such as the ground. Bias voltage Vbias is applied to the gate of the biasing transistor Mₙₘₐᵢₙ. The collectors of the transistor devices Q_{casm} and Qₐᵤₓₘ are connected across the load Zload. A bias voltage Vaux is applied to the base of the transistor Qₐᵤₓₘ and the bias voltage Vcas to the base of the transistor Q_{casm}.

Basically, the amplitude control is implemented by changing the biasing and operations point currents of the main cascade branch Q_{cas} and the by-pass cascade branch Qₐᵤₓ with respect to each other. In this example, the voltage difference between the voltages V_{cas} and Vₐᵤₓ is varied. The impedance at the interconnection point remains constant and the phase remains constant but a current-type power division is formed between the cascade branches.

The phase is shifted by changing the sum current of the cas and aux branches, and therefore an additional current path is established through the resistor R_{LPF} so that the operational point of the input transistor Qin is constant independently from the phase control. The sum current is adjusted by means of the biasing voltage of the transistor _{Mptune} and/or _{Mntune}.

FIG. 14 is a graph showing the change in phase behaviour (A mag & phase and B in polar format) of the circuit of FIG. 13 when sum current Ic(Qcas)+Ic(Qauc) is tuned but the relation of the currents is constant Ic(Qcas)/Ic(Qaux)=constant. The amplitude can be tuned by relative adjust of Ic(Qcas) and Ic(Qaux) (not shown in the FIG. 14).

Second Aspect of the Invention

Examples of embodiments implementing the principles of the second aspect of the invention, which based on the current summing of generated polyphase signals, are now described. The summing of these intentionally generated polyphase signals enables to produce an output signal with desired amplitude and phase. In preferred embodiments of the invention, the polyphase signals include four phase components that are in approximately 90 degree phase shift with each other, i.e. quadrature-phased. This approach enables a wider range of adjustment and a less complicated practical implementation.

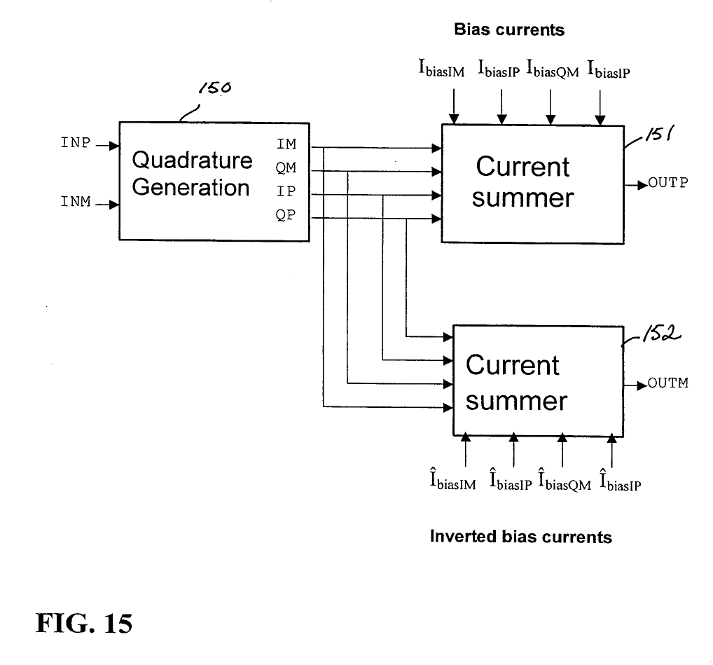

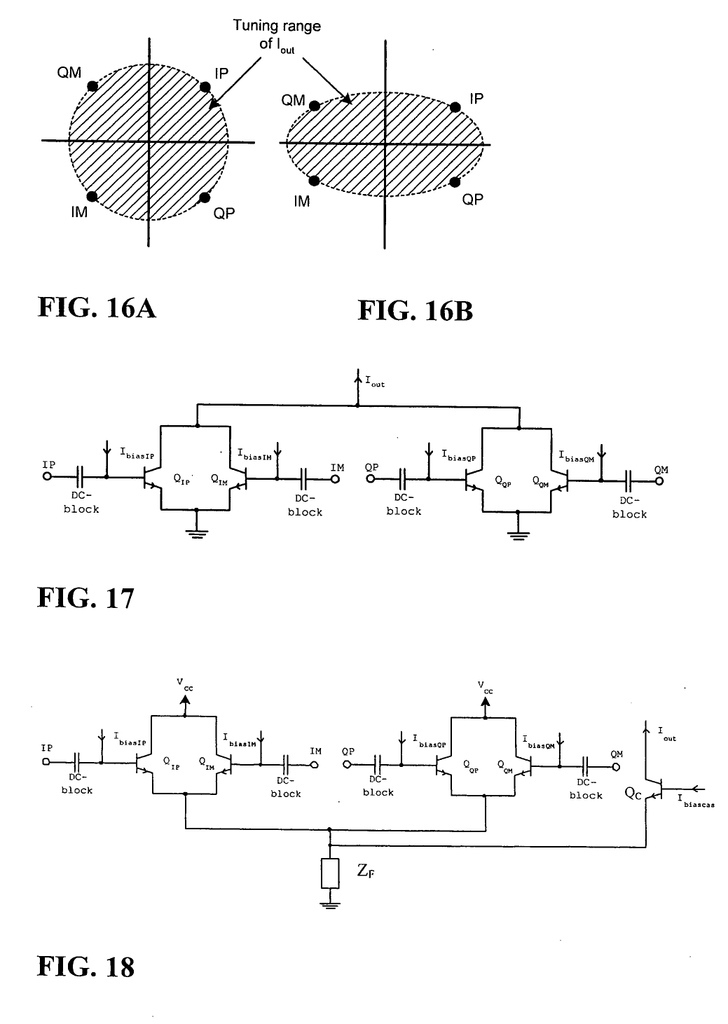

FIG. 15 shows an example of a signal adjuster according to the second aspect of the invention for a general differential application. A polyphase generation block 150 generates polyphase output signals IM, QM, IP, and QP from the differential signals INP and INM applied the inputs of the generation block 150. In the example of FIG. 15, the polyphase output signals IM, QM, IP, and QP are quadrature-phased, i.e. in approximately 90 degree phase shift with each other. In a polar coordination, the phases of the signals IM, QM, IP, and QP are ideally located in different quarters, as shown in FIG. 16A. In practice, the location of the signals in the polar coordination may be distorted and non-ideal, due to the influence of a polyphase vector error, as illustrated in FIG. 16B. The polyphase generation, and especially the quadraturizing of the signal can be done with traditional methods such as RC-polyphase filter, RL-polyphase filter or divided-by-two-circuitries. The quality of quadrature signal is not essential, and therefore, e.g. first order RC-polyphase filter provides a satisfactory performance. Influence of the error in quadrature signals to a tuning range of a current summer is illustrated in FIGS. 16A and 16B. As can be seen from FIG. 16B, the error will distort the tuning range of the output current Iₒᵤₜ from the ideal circle, but the tuning range will remain satisfactory even with a phase error of 20-30 degrees.

The generated quadrature signals IM, QM, IP, and QP are applied to current summers 151 and 152 which sum the signals and provide single-ended output signals OUTP and OUTM, respectively. The summing operation of the current summer 151 is controlled by means of the bias currents I_{biasIP}, I_{biasIM}, I_{biasQP}, and I_{biasQM}. The summing operation of the current summer 152 is controlled by means of the inverted bias currents Î_{biasIP}, Î_{biasIM}, Î_{biasQP}, and Î_{biasQM}, so as to achieve the differential operation. The bias currents may be provided by any suitable current source, such as a simple current-mode digital-to-analog converter (IDAC). The current source or IDAC may be controlled by digital control data from a controller so as to output desired bias currents.

An example of a current summer 151 is shown in FIG. 17. The illustrated current summer utilizes a common-emitter (CE) transistor configuration. The quadrature signals IP and IM are applied through the DC-block capacitors to base electrodes of a common-emitter connected transistor pair Q_{IP} and Q_{IM}. Bias currents Î_{biasIP} and Î_{biasIM} are also applied to the base electrodes of the transistors Q_{IP} and Q_{IM}. Similarly, The quadrature signals QP and QM are applied through the DC-block capacitors to base electrodes of a common-emitter connected transistor pair Q_{QP} and Q_{QM}. Bias currents Î_{biasQP} and Î_{biasQM} are also applied to the base electrodes of the transistors Q_{QP} and Q_{QM}. The collectors of the transistor pair are interconnected to provide the sum current I_{OUT}. The current summer 152 in the other differential branch has same configuration but now the controlling bias currents Î_{biasIP}, Î_{biasIM}, Î_{biasQP}, and Î_{biasQM} are the inverted versions of those of the current summer 151. As a result, the phase difference between the differential branches OUTP and OUTM is always approximately 180 degrees, independently from the vector errors in the inputted quadrature signals. Further, the current consumption within the selected control range is substantially constant in different controls, and the control is a difference-mode, so that e.g. the current I_{biasIP}+I_{biasIM} is always substantially constant in both differential branches.

It should be appreciated that the circuit shown in FIG. 15 is only an example, and a current summer according to the invention can be based on any common-emitter, common-base or common-collector transistor configuration. A current summer utilizing a folded cascoded common-collector transistor configuration is shown in FIG. 18. The configuration is quite similar to that of FIG. 17, except that the output, i.e. the current summing point, is now at the interconnected emitters of transistors Q_{IP}, Q_{IM}, Q_{QP} and Q_{QM}.

In order to minimize an error factor in the frequency band due to parasitics, the current summing point (the output current I_{OUT}) is preferably buffered with a low-impedance transistor stage. In the embodiment shown in FIG. 18, the current summing point (the output current I_{OUT}) is buffered with a low-impedance folded cascode stage formed by the common- base connected transistor Q_{C} and the folding impedance Z_{L}. The folding impedance may be resistive (R), inductive (L), or a current source, for example. As an alternative to the folded cascode, a traditional cascode stage may be used.

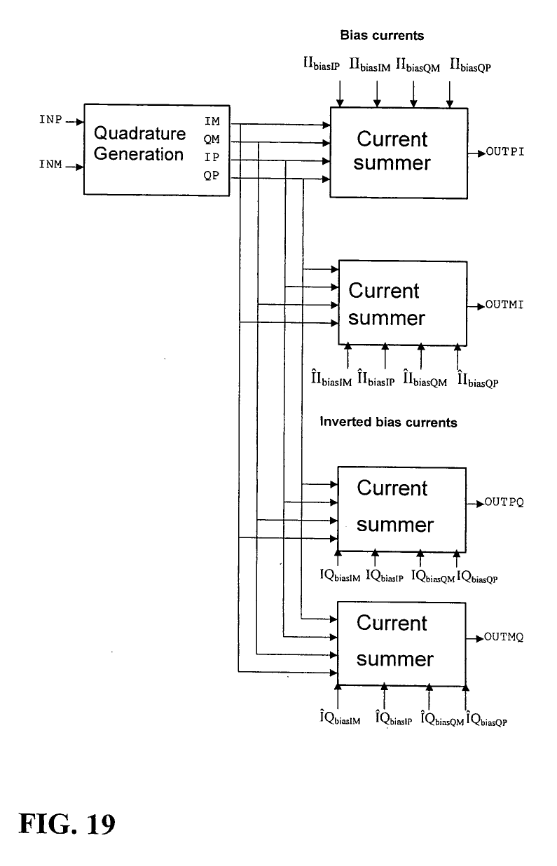

As noted above, the quadrature generation of local oscillator (LO) signal with a divided-by-two circuitry or a passive polyphase filter cause an error vector lowering the performance of these circuits in some applications. A wide application area among the quadrature LO signal generation can be covered when the current summers and the outputs are multiplied. FIG. 19 shows an example of a signal response adjuster suitable for a quadrature LO operation to compensate the error vector of a divided-by-two circuitry or a high frequency polyphase filter. Another major application area is the enlarging of the high performance frequency bandwidth of the passive polyphase filter in high frequency and high frequency solutions.

In FIG. 19, the polyphase or quadrature generation and the configuration of an individual summer can be same as in the embodiments described above. Two of the current summers may have bias currents II_{biasIP}, II_{biasIM}, II_{biasQP}, and II_{biasQM} as well as \hat{II}biasIP, \hat{II}_{biasIM}, \hat{II}_{biasQP}, and \hat{II}_{biasQM} similar to those of the embodiments described above, and the current summers produce outputs OUTPI and OUTMI, respectively. Other two current summers have bias currents which are in quadrature phase in relation to those of the first two current summers, thereby producing outputs OUTPQ and OUTMQ. These bias currents are designated as IQ_{biasIP}, IQ_{biasIM}, IQ_{biasQP}, and IQ_{biasQM} as well as ÎQ_{biasIP}, ÎQ_{biasIM}, ÎQ_{biasQP}, and ÎQ_{biasQM}. As a result we have four outputs whose phases are located in different quarters in a polar coordination.

### APPLICATION EXAMPLES

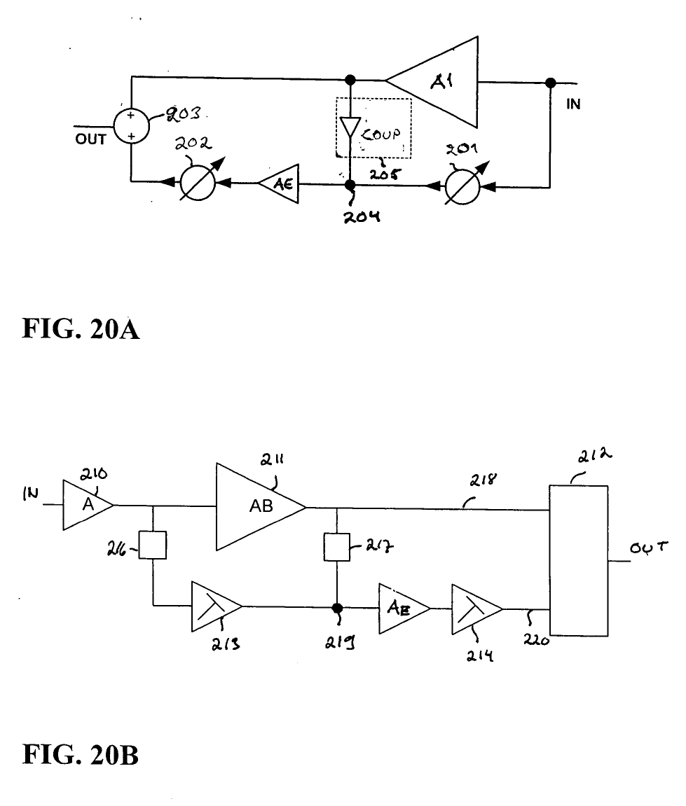

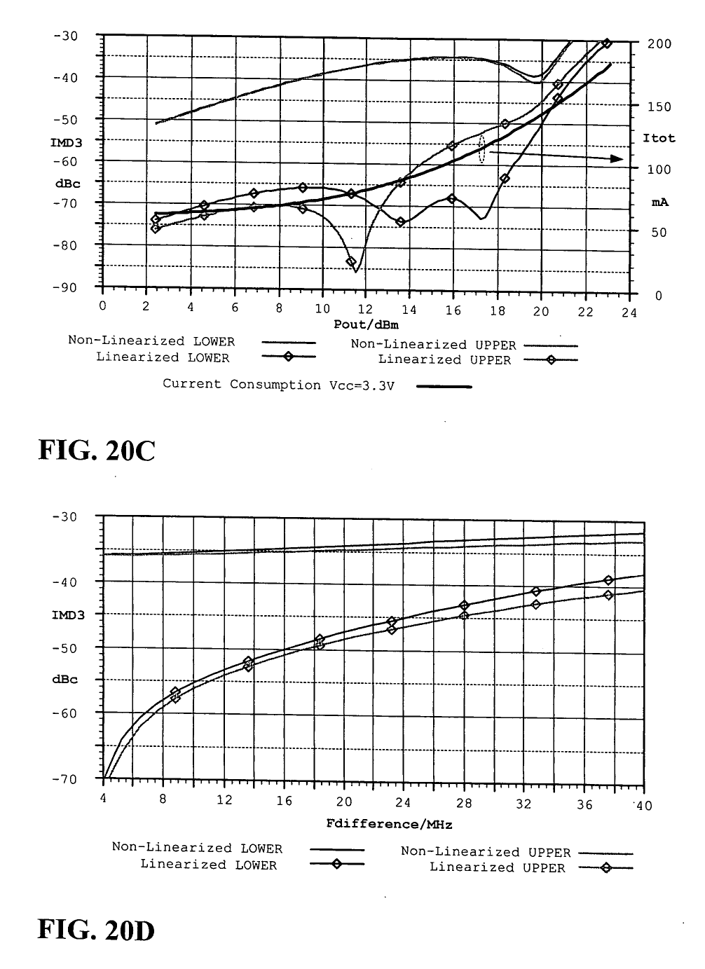

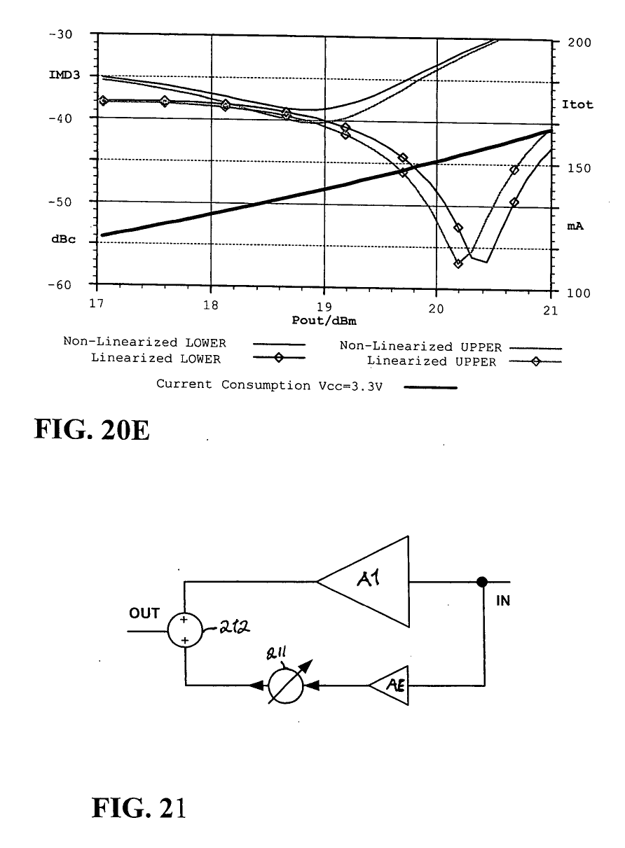

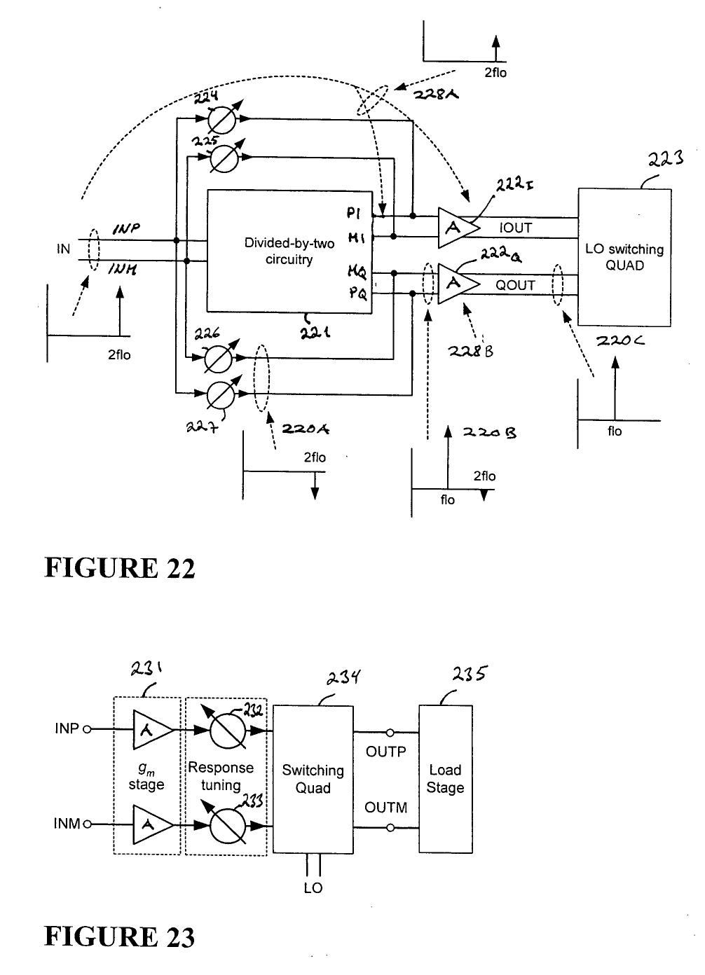

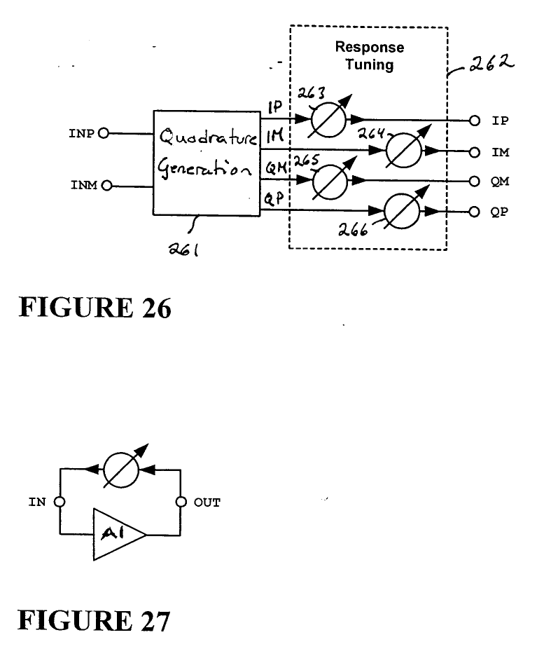

In the following, application examples using on-chip signal response adjusters according to the present invention are described. The applications described include: Odd-order linearizations shown in FIGS. 20 and 21; Even-order linearizations shown in FIG. 22-24; Isolation boosting shown in FIG. 25; Modulation correction shown in FIG. 26; and General feedback systems VGA/VCO shown in FIG. 27.

Odd-Order Linearization of Transceiver

As an example, FIG. 20A shows a feedforward type of linearization with a signal cancellation loop to operation especially with low back-off. The RF input signal IN is amplified with a main amplifier A1 and the amplified signal is applied to a first input of an output coupling device 203. The input signal IN is also inputted to a response tuning or adjusting device 201 according to the present invention. The output of the response adjuster 201 is inputted to an error amplifier AE, together with a feedforward signal coupled from the output of the main amplifier A1 by means of an active and/or resistive coupling device 205. Thus, the fundamental cancellation of the signals occurs at the node 204, thereby producing an error signal which is amplified by the error amplifier AE and applied to a second response tuning or adjusting device 202 according to the present invention. The output of the response adjuster 202 is applied to a second input of the output coupling device 203 that sums the signals thereby producing a distortion suppression in an RF output signal OUT.

A short design cycle for a silicon-germanium (SiGe) power amplifier (PA) for short-range base station applications is examined. below A two stage SiGe power amplifier used as a core for linearization training is shown in FIG. 20B. The first amplifier stage 210 is fully in A-class and the second amplifier stage 211 is in AB-class. The overall performance of the power amplifier itself is relatively poor.

The target is to meet BTS requirements for +20 dBm output power with using a classic feedforward linearization method. The output summing is implemented by an external power combiner 212 to maintain better non-linearity tracking on the non-linear device (AB) itself. Any kind of passive combiner 212 is feasible. The most important requirement for the combiner 212 is a sufficient port isolation to not mix the linearized signal with the non-linear signal.

The response mechanisms based on the RC-polyphase current summers 213 and 213 is utilized because of the adaptivity and large tuning range of the signal response. The current summers 213 and 214 implement the response adjusters 201 and 201, respectively, in FIG. 20A. Resistive couplings 216 and 217 couple outputs of amplifier stages 210 and 211 to the input and output, respectively of the current summer 213. Coupler 217 implements the coupling device 205 in FIG. 20A. Fundamental canceling occurs at the output 19 of the current summer 213. Signal 218 is the main output signal and the signal 220 is the error output signal which are combined in the combiner 212.

It should be appreciated that the only purpose of the circuit shown in FIG. 20B is to evaluate the feasibility of this type of linearization circuitry. The simulation results are illustrated in FIGS. 20C, 20D and 20E. In these simulations, the external output coupling is not modelled and an ideal signal summing is performed. Furthermore, the electrical length of the output coupling or the on-chip signal paths is ignored as well as the package modelling. It is notable that the actual sizes of the devices inside the power amplifier chip are relatively large and this electrical length is causing error in a wideband operation of the linearization.

FIG. 20C illustrates behavior of a linearized power amplifier in power domain (IMD3 vs. Pout) with input tones at 1948 MHz and 1952 MHz. The thicker black line represents the current consumption as a function of output power. For example. output power of +15 dBm is feasible even with very high crest factor.

FIG. 20D illustrates a response of a linearized PA in frequency domain (f₁=1950 MHZ-f_{difference}/2 & f₂=1950 MHZ+f_{difference}/2) at output power of +13 dBm.

FIG. 20E illustrates behavior of a slightly tuned (with current summers) linearization circuitry optimized for higher output power. The linearization is narrower over the power domain. As another example, FIG. 21 shows a feedforward type of linearization without a signal cancellation loop to operation especially with higher back-off. The RF input signal IN is amplified with a main amplifier A1 and the amplified signal is applied to a first input of an output coupling device 212. The input signal IN is also inputted to a response tuning or adjusting device 211 according to the present invention. The output of the response adjuster 211 is applied to a second input of the output coupling device 212 that sums the signals thereby producing a distortion suppression in an RF output signal OUT.

When the circuitry of FIG. 20 is used as a linearized power amplifier operating with small back-off, an external output coupling 203 can be preferred. When circuitries of FIGS. 20 and 21 used as an analog predistorter to linearize an external power amplifier, or are used as an amplifier with high back-off, an on-chip output coupling 203 or 212 can be utilized.

Advantages of the response adjusters according to the present invention in linearization include:
Miniaturization gives clear price competitiveness in many levels.
Wideband operation; the response tuning is performed practically without electrical length
Adaptivity; linearization can be easily scaled to different operation modes without component modification: different frequency or power ranges, or the linearization can be even shut down to operate as a conventional amplifier
An accurate tuning resolution can be easily arranged inside an RFIC.
This enables a high quality linearization resulting large suppression of the intermodulation distorsion.
   Even-Order Linearization of a Direct Conversion Mixer

As an example, FIG. 22 shows a circuitry for optimization of LO duty-cycle of the local oscillator (LO) chain for down- or up-conversion mixer operation. Duty-cycle is an essential quantity for direct-conversion operation. A differential input In having a frequency 2flo is inputted to a divided-by-two circuitry 221 which produces differential quadrature outputs I and Q having ideally a frequency flo. The quadrature outputs I and Q are applied through differential amplifiers 222_{I} and 222_{Q} to a LO switching QUAD 223. A problem with such circuitry is caused by a coupling of a pseudo second-harmonic due to a substrate isolation and device mismatches, for example, as illustrated by broken line 228A, and a second harmonic generated by active devices, as illustrated by broken line arrow 228B. The situation is dominated by second harmonic especially when divided-by-two circuitry is utilized, since the substrate isolation at GHz range is poor. Therefore, response tuning or adjusting devices 224, 225, 226 and 227 are connected between the differential inputs and outputs of the divided-by-two circuitry 221 to compensate or cancel the undesired harmonic frequencies. Basically the compensation can be performed only at spot frequency 2of, because there are no requirements for wide frequency range. More specifically, the response adjuster 224 is provided between the first differential signal input P and the first differential signal output PI, the response adjuster 225 is provided between the second differential signal input M and the second differential signal output MI, the response adjuster 226 is provided between the second differential signal input M and the third differential signal output MQ, and the response adjuster 227 is provided between the first differential signal input P and the third differential signal output PQ, of the divided-by-two circuitry 221. Each of the signal adjusters 224 provide a compensating signal at the second harmonic frequency 2flo (as illustrated at 220A). so that the undesired second harmonics at the outputs of the amplifiers 222 are substantially cancelled (as illustrated at 220A and 220C). The compensation can cancel both the differential and common-mode second harmonic, respectively. As a result, there are no second harmonics, and the duty-cycle is near 50%

As another example, FIG. 23 shows a signal balance compensation of a direct-down-conversion mixer to improve performance in even-order and/or quadrature error (I/Q-balance). Differential signal inputs INP and INM are supplied through a transconductance (gₘ) amplifier stage having two amplifier branches, to response tuning or adjusting devices 232 and 233, respectively, according to the present invention. The adjusted signals are inputted to a switching quad 234 and down-converted, using the local oscillator signal LO, into differential output signals OUTP and OUTM which are inputted to a load stage 235. As a result, the balance of the differential signal branches P and M can be adjusted in relation to each other by means of the response adjusters according to the invention.

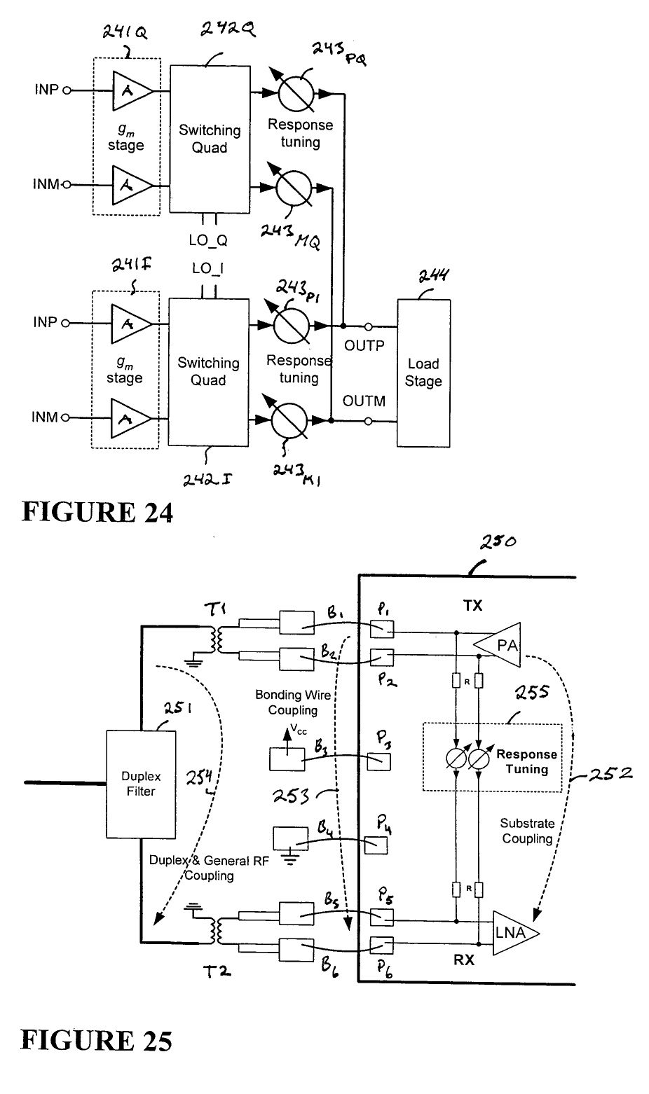

As a still further example, FIG. 24 shows signal balance compensation of a direct-up-conversion mixer to improve performance in LO-leaking and/or quadrature error (I/Q-balance). Differential signal inputs INP and INM are supplied through transconductance (gₘ) amplifier stages 241Q and 241I each having two amplifier branches, to switching quads 242Q and 242I, respectively. In the switching quads 242Q and 242I, the amplified signals are upconverted using the local oscillator signals LO_Q and LO_I, respectively. The upconverted signals are applied to response tuning or adjusting devices 243_{PQ}, 243_{MQ}, 243_{PI}, and 243_{PQ}. The outputs of the switching quads 243_{PQ} and 243_{PI}, are combined to form a differential output OUTP, and the outputs of the switching quads 243_{MQ} and 243_{MI} are combined to form a differential output OUTM. The outputs OUTP and OUTM are inputted to a load stage 244. As a result, the balance of the differential signal branches P and M can be adjusted in relation to each other by means of the response adjusters according to the invention.

Isolation Boosting

All kind of interference (differential & common-mode) can be cancelled by use of the response adjusters according to the present invention in an isolation-boosting configuration to compensate multiple interference sources from one sensitive part or two interference sources from each other. This can be easily derived by superposition method. Examples on applications in system on chip concepts include: Transceiver (TRX) chips with TX or TX-LO interfering a receiver (RX); Harmonics of comparison frequency or prescaler output interfering RX in on-chip LO systems; and Cross interference between multiple LOs. Examples on applications in multiradio concepts (on-chip or out-of-chip interference) include: Mobile PA interfering a GPS receiver of the same phone; and cross modulation compensation, e.g. TX to RX can be also seen as a trade-off in duplex filtering. (Co-siting or TRX chips).

As an example of implementation, FIG. 25 shows the isolation boosting of TX output from a low-noise amplifier (LNA) input. A transceiver chip 250 comprises a number of input and output pins P₁-P₆ or other contacts which are connected to out-of-chip circuitry by means of bonding wires B₁-B₆ or other bonding method. A transmitter part TX of the transceiver chip 250 comprises an on-chip RF power amplifier PA. The differential RF output of the PA is applied through output pins P₁, P₂ to the out-of-chip circuitry. The differential output signal is transformed into a single ended signal in a transformer T1, and the single-ended signal is fed to an antenna through a duplex filter 251. In reception, a received RF signal is fed from the antenna through the duplex filter 252 to a transformer T2. The transformer T2 produces a differential reception signal which is applied to input pins P₅, P₆ of the TRX chip 250 and further to an on-chip low-noise amplifier LNA. There are various on-chip and out-of-chip interference paths for a transmission signal to leak to the receiver branch. Some of these interference paths are generally illustrated by broken arrows 252, 253 and 254. A response tuning unit 255 composed of a pair of response adjusters according to the present invention are connected between the output of the power amplifier PA and the input of the LNA to form a controllable differential interference path with opposite phase and equal amplitude compared to the cumulative interference environment.

Modulation Correction

FIG. 26 shows an example of a general quadrature compensation to improve the quality of modulation (EVM). A polyphase generation block 261 generates polyphase output signals IM, QM, IP, and QP from the differential signals INP and INM applied the inputs of the generation block 261. The polyphase generation block 261 can be similar to that described with reference to FIG. 15. The generated polyphase or quadrature signals IM, QM, IP, and QP are applied to response adjusters 263, 264, 265, and 266, respectively, according to the present invention in a response tuning unit 262. The response adjusters are tuned to compensate amplitude and phase behaviour of modulation so as to enable high quality modulation and/or to enlarge the operation frequency bandwidth.

Adjustable Feedback Circuits

FIG. 27 shows a general configuration of adjustable feedback for an amplifier and oscillator purposes. An active feedback of an amplifier A1 is provided by feedbacking the output OUT to the input IN through a response adjuster according to the invention. The active feedback can be operating as a linearization loop at least for moderate high back off. Variety of different adjustable feedback loops can be implemented, such as PGA, VGA, VCO.

It should be noted that although a drawing symbol representing the invented on-chip response mechanisms is shown as single-ended for simplificity in FIGS. 20-27, the actual implementation may be and almost without an exception is a differential configuration. Any response adjuster according to the present invention can be used for implementing the response adjusters in FIGS. 20-27.

When using the RL HPF & RC LPF cascode structures according to the first aspect of the invention, the cascoding may be made with/without auxiliary (Qaux) branch: amplitude and phase tuning can be arranged separately in different points/blocks of the radio path. The cascading may be folded cascoding or conventional cascading with single-ended or differential topologies. Different transistor polarities and types, such as pMOS, nMOS, npn, pnp, etc., and different RFIC processes, such as Si, SiGe, GaAs, etc, may be used.

When using a quadrature generation with current summing according to the second aspect of the invention, the quadrature generation may be based on a 1^{st}-n^{th}-order RC, RL, or RLC polyphase filter, or a divided-by-two circuitry. In the current summing a variety of circuit topologies can be utilized, such as basic amplifier topologies with/without folding and/or cascading.

It will be obvious to a person skilled in the art that, as the technology advances, the inventive concept can be implemented in various ways. The invention and its embodiments are not limited to the examples described above but may vary within the scope of the claims.

1. An on-chip circuit for radio frequency signals, comprising a first cascode transistor device forming a main cascode branch, a second transistor device forming a by-passed cascode branch, a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.

2. A circuit according to claim 1, wherein said adjustable impedance is a combined input impedance of the main and by-passed cascode branches.

3. A circuit according to claim 1, wherein said parallel-connected frequency-variant component comprises an inductor, which together with the adjustable impedance forms a RL high-pass filter.

4. A circuit according to claim 1, wherein said parallel-connected frequency-variant component comprises a capacitor device that together with the adjustable impedance forms a RC low-pass filter.

5. A circuit according to claim 4, wherein said capacitor device comprises a switching matrix having two or more capacitor selectable by switches.

6. A circuit according to claim 1, wherein the independent operation point control of the first and second cascode transistors comprises independent biasing of the first and second cascode transistors.

7. A circuit according to claim 1, wherein the cascode configuration is a folded cascode configuration.

8. An on-chip circuit for radio frequency signals, comprising
a polyphase generator configured to generate at least two signals of mutually different phases from an input signal, and
a current summer configured to sum the signals of mutually different phases to produce an output signal with a desired signal response.

9. A circuit according to claim 8, wherein said at least two signals of mutually different phases include at least an in-phase output signal and a quadrature output signal generated from the input signal.

10. A circuit according to claim 8, wherein the polyphase generator has a differential input and is configured to form a differential in-phase output signal and a differential quadrature output signal, and wherein the current summer comprises
a first current summer configured to sum the differential in-phase output signal and the differential quadrature output signal and to output a first single-ended sum signal, said first current summer having a dedicated adjustable biasing for each of the differential signals so as to enable adjustment of the signal response of the first single-ended sum signal, and
a second current summer configured to sum the differential in-phase output signal and the differential quadrature output signal and to output a second single-ended sum signal, said current summer having a dedicated adjustable inverted biasing for each of the differential signals so as to enable adjustment of the signal response of the second single-ended sum signal, said first and second single-ended signals forming a differential output signal.

11. A circuit according to claim 10, further comprising
a third current summer configured to sum the differential in-phase output signal and the differential quadrature output signal and to output a third single-ended sum signal, said first current summer having a dedicated adjustable quadrature-phased biasing for each of the differential signals so as to enable adjustment of the signal response of the third single-ended quadrature sum signal,
a fourth current summer configured to sum the differential in-phase output signal and the differential quadrature output signal and to output a fourth single-ended sum signal, said current summer having a dedicated adjustable inverted quadrature-phased biasing for each of the differential signals so as to enable adjustment of the signal response of the fourth single-ended sum signal, said first and second single-ended signals forming a differential in-phase output sum signal, and said third and fourth single-ended signals forming a differential quadrature output sum signal.

12. A circuit according to claim 10, wherein said differential in-phase output signal comprises a first in-phase output signal and a second in-phase output signal with a 180° phase difference, and said differential quadrature output signal comprises a first quadrature output signal and a second quadrature output signal with a 180° phase difference.

13. A circuit according to claim 8, wherein said polyphase generator comprises one of: a RC/RL polyphase filter; a RC/RC polyphase filter; and a divide-by-two circuit.

14. A circuit according to claim 10, wherein at least one of said current summers comprises
a first differential transistor stage having a pair of input electrodes for receiving the differential in-phase output signal from the quadrature generator, and a first output electrode,
a second differential transistor stage having a pair of input electrodes for receiving the differential quadrature output signal from the quadrature generator, and a second output electrode interconnected with the first output electrode to provide a single-ended sum signal,
separate adjustable biasing current at each of said input electrodes so as to enable adjustment of the signal response of the single-ended sum signal.

15. A circuit according to claim 14, wherein said first and second differential transistor stages is in a common-emitter transistor configuration or in a folded cascaded common-collector transistor configuration.

16. An integrated RF linearizer circuit, comprising
an on-chip circuit, said on-chip circuit further including a first cascode transistor device forming a main cascode branch,
a second transistor device forming a by-passed cascode branch,
a parallel-connected frequency-variant component, and
independent operation point control of the first and second cascode transistors providing an adjustable impedance which together with the parallel-connected frequency-variant component device forms a controllable transfer zero or a controllable transfer pole in a transfer function of the circuit.

17. An integrated circuit, comprising
a feedforward type of linearization with a signal cancellation loop,
an on-chip circuit both in the signal cancellation loop and in a feed-forward branch, said on-chip circuit further including
a first cascode transistor device forming a main cascode branch,
a second transistor device forming a by-passed cascode branch,
a parallel-connected frequency-variant component, and
independent operation point control of the first and second cascode transistors providing an adjustable impedance which together with the parallel-connected frequency-variant component device forms a controllable transfer zero or a controllable transfer pole in a transfer function of the circuit.

18. An integrated RF linearizer circuit, comprising
a feedforward type of linearization without a signal cancellation loop,
on-chip circuit in a feedforward branch, said on-chip circuit further including
a first cascode transistor device forming a main cascode branch,
a second transistor device forming a by-passed cascode branch,
a parallel-connected frequency-variant component, and
independent operation point control of the first and second cascode transistors providing an adjustable impedance which together with the parallel-connected frequency-variant component device forms a controllable transfer zero or a controllable transfer pole in a transfer function of the circuit.

19. An integrated circuit direct conversion mixer comprising
an on-chip even-order linearizer circuit, said on-chip circuit further including a first cascode transistor device forming a main cascode branch,
a second transistor device forming a by-passed cascode branch,
a parallel-connected frequency-variant component, and
independent operation point control of the first and second cascode transistors providing an adjustable impedance which together with the parallel-connected frequency-variant component device forms a controllable transfer zero or a controllable transfer pole in a transfer function of the circuit.

20. An integrated circuit direct up-conversion mixer, comprising
differential input for receiving first and second differential input signals having a frequency flo,
a divided-by-two circuitry which produces from the first differential input signal a first in-phase output signal and a first quadrature output signal having ideally a frequency flo, and which produces from the second differential input signal a second in-phase output signal and a second quadrature output signal having ideally a frequency flo,
a first differential amplifier for amplifying the first and second in-phase signal,
a second differential amplifier for amplifying the first and second quadrature signals,
a first response adjuster provided between the first differential signal input and the first in-phase signal output,
a second response adjuster provided between the first differential signal input and the first quadrature signal output,
a third response adjuster provided between the second differential signal input and the second in-phase signal output,
a fourth response adjuster provided between the second differential signal input and the second quadrature signal output, and wherein the first, second, third, and fourth response adjusters each comprises on-chip circuit, each of said on-chip circuits further including
a first cascode transistor device forming a main cascode branch,
a second transistor device forming a by-passed cascode branch,
a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.

21. An integrated circuit direct up-conversion mixer, comprising
a transconductance amplifier stage having a pair of differential signal inputs, a respective pair of amplifier branches, and a respective pair of differential signal outputs,
a pair of on-chip circuits having inputs for receiving said pair of differential output signals and for providing a pair of adjusted differential output signals, each of said on-chip circuits further including
a first cascode transistor device forming a main cascode branch,
a second transistor device forming a by-passed cascode branch,
a parallel-connected frequency-variant component, and
independent operation point control of the first and second cascode transistors providing an adjustable impedance which together with the parallel-connected frequency-variant component device forms a controllable transfer zero or a controllable transfer pole in a transfer function of the circuit.

22. An integrated circuit direct up-conversion mixer, comprising
a first transconductance amplifier stage having a pair of differential signal inputs, a respective pair of amplifier branches, and a respective first pair of differential signal outputs,
a first switching quad for switching, under control of an in-phase local oscillator signal, of said first pair of differential signal outputs to a first pair of on-chip circuits according to claim I so as to provide a first pair of adjusted differential output signals,
a second transconductance amplifier stage having a pair of differential signal inputs, a respective pair of amplifier branches, and a respective second pair of differential signal outputs,
a second switching quad for switching, under control of a quadrature local oscillator signal, of said second pair of differential signal outputs to a first pair on-chip circuits so as to provide a second pair of adjusted differential output signals to be combined with the first pair of adjusted differential output signals, each of said on-chip circuits further including
a first cascode transistor device forming a main cascode branch,
a second transistor device forming a by-passed cascode branch,
a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.

23. An integrated circuit, comprising
at least one on-chip circuit in an isolation-boosting configuration to compensate multiple interference sources from one sensitive part or two interference sources from each other, said on-chip circuit further including
a first cascode transistor device forming a main cascode branch,
a second transistor device forming a by-passed cascode branch,
a parallel-connected frequency-variant component, and
independent operation point control of the first and second cascode transistors providing an adjustable impedance which together with the parallel-connected frequency-variant component device forms a controllable transfer zero or a controllable transfer pole in a transfer function of the circuit.

24. An integrated circuit, comprising
an on-chip power amplifier providing the transmitter output,
an on-chip low-noise amplifier receiving a reception signal,
at least one on-chip isolation boosting circuit provided between the output of the power amplifier and the input of the low noise amplifier to form a controllable interference path with substantially opposite phase and equal amplitude compared to interference leaking to the receiver input from the transmitter output, said on-chip circuit further including
a first cascode transistor device forming a main cascode branch,
a second transistor device forming a by-passed cascode branch,
a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.

25. An integrated circuit, comprising
at least one on-chip modulation correction circuit, modulation, said on-chip circuit further including
a first cascode transistor device forming a main cascode branch,
a second transistor device forming a by-passed cascode branch,
a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.

26. An integrated circuit, comprising
a polyphase generator with a number of polyphase output signals generated from the differential input signals, and
a respective number of adjustable modulation amplitude and phase behavior compensator on-chip circuits, each of said on-chip circuits further including
a first cascode transistor device forming a main cascode branch,
a second transistor device forming a by-passed cascode branch,
a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.

27. An integrated circuit, comprising
an amplifier or an oscillator,
at least one on-chip adjustable feedback circuit for the amplifier or the oscillator, said on-chip circuit further including
a first cascode transistor device forming a main cascode branch,
a second transistor device forming a by-passed cascode branch,
a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.

28. An integrated circuit direct up-conversion mixer, comprising
a first transconductance amplifier stage having a pair of differential signal inputs, a respective pair of amplifier branches, and a respective first pair of differential signal outputs,
a first switching quad for switching, under control of an in-phase local oscillator signal, of said first pair of differential signal outputs to a first pair of on-chip circuits according to claim 8 so as to provide a first pair of adjusted differential output signals,
a second transconductance amplifier stage having a pair of differential signal inputs, a respective pair of amplifier branches, and a respective second pair of differential signal outputs,
a second switching quad for switching, under control of a quadrature local oscillator signal, of said second pair of differential signal outputs to a first pair on-chip circuits so as to provide a second pair of adjusted differential output signals to be combined with the first pair of adjusted differential output signals, each of said on-chip circuits further including
a first cascode transistor device forming a main cascode branch,
a second transistor device forming a by-passed cascode branch,
a parallel-connected frequency-variant component, and independent operation point control of the first and second cascode transistors providing an adjustable impedance which together with the parallel-connected frequency-variant component device forms a controllable transfer zero or a controllable transfer pole in a transfer function of the circuit.
